(19) United States
(12) Patent Application Publication
(10) Pub. No.: US 2009/0082037 A1
(43) Pub. Date: Mar. 26, 2009

(54) PERSONAL POINTS OF INTEREST IN LOCATION-BASED APPLICATIONS

(75) Inventors: Yun-Cheng Ju, Bellevue, WA (US); Michael Seltzer, Seattle, WA (US); Ivan J. Tashev, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/860,433

(22) Filed: Sep. 24, 2007

(51) Int. Cl. H04Q 7/20

(52) U.S. Cl. 455/456.3

(57) ABSTRACT

Framework for receiving, processing, and re-using personal points of interest (PPOI) information of a user in a location-based application. A telephone dialog system provides location-based information related PPOI of a user. For example, the PPOI information can include major intersections that the user may normally travel, gas stations, clubs, etc., based on real-time data obtained via web services. The PPOI information can be acquired using common names and nicknames, which are added into system lexicon and recognition grammars. Each PPOI is also tagged to the user (or “owner”) who defined it. The PPOI information can also be shared to support a community of users. The framework also resolves conflicting PPOI information between multiple users and multiple locations. PPOI information input by one user can be used to extract demographic information and personal preferences and be re-used by other users by automatically popping up common names and attributes other users entered for the same nickname.

### BACKGROUND

Location-aware applications (e.g., navigation, map, directory assistance, traffic/weather update, etc.) are receiving more attention due to the advances of technology and popularity of data networks. The availability of online maps and mapping software has led to a dramatic increase in location-based services such as for route planning, navigation, and locating nearby businesses. One big problem these types of applications face in usability and productivity is conveying the locations, especially the “personal push pins” such as home and work.

While much of the effort has been focused on bringing these applications and services to desktop computer users, there is a demand for these services to be available to mobile users. A significant portion of mobile users will utilize these services from a vehicle while driving. The automotive environment is a particularly challenging, because operating a vehicle is a hands-busy and eyes-busy task, making the use of touch screens or pointing devices potentially unsafe. In contrast, using speech as both an input and output modality is a natural and safe means of interacting with information. The most critical part of a dialog system for location-based services is how well the system understands location terminology spoken by the user. It would be very beneficial and expedient for a user to be able to issue commands or queries in a natural language format such as “What's the traffic like from work to home?” or “Where is the cheapest gas station near my gym?” and receive useful information back.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed framework includes a mechanism for receiving, processing, navigating and re-using personal points of interest (PPOI) information of a user in a location-based application. Information harvested from the PPOI significantly improves system performance and user satisfaction. To effectively support this, the framework handles at least the declaration, reference resolution, sharing, and re-use of PPOI information.

In one embodiment, a voice dialog system (e.g., telephone) allows users to denote location-based information in the form of PPOI. In other words, the dialog system is personalized to a particular user so that the PPOI are known by the system. As a telephone dialog system, any user with a cell phone, for example, can access these services without the need for a data plan or additional hardware or software installed in the vehicle. For example, the PPOI information can include major intersections that the user may normally travel, gas stations, clubs, etc., based on real-time data obtained via web services.

The PPOI information can be acquired using common names and nicknames, which are added into system lexicon and recognition grammars. This information can then be leveraged from personal settings such as PIMs (personal information managers) and/or other web services. Each PPOI is also tagged to the user (or “owner”) who defined it. The PPOI information can also be shared to support a community of users. The framework also resolves conflicting PPOI information between multiple users and multiple locations. PPOI information input by one user can be re-used by other users thereby simplifying the task of entering the PPOI by automatically popping up common names and attributes other users entered for the same nickname.

The framework by the fact of receiving large amounts of information in the form of PPOI can be used to harvest the demographic information and personal preferences which are very useful to provide targeted services and advertisements (or content). Examples include gender and marital status obtained from names (e.g., “My Wife's Office”, “My Daughter's School”), life style and activities of interest (e.g., “My gym”, “My art class”), work, home, income level, and favorite restaurants

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a location-based system for providing location information based on PPOI.

FIG. 2 illustrates an alternative system for acquiring and supporting PPOI information for location-based services.

FIG. 3 illustrates the inputs provided and related for location-based services based on PPOI information.

FIG. 4 illustrates an exemplary speech dialog system for obtaining location-based services based on PPOI information.

FIG. 5 illustrates a method of providing location-based services.

FIG. 6 illustrates a method of registering for location-based services using PPOI information.

FIG. 7 illustrates a method of retrieving location-based information based on a phone call.

FIG. 8 illustrates a method of automatically enabling a default operating profile based on temporal information.

FIG. 9 illustrates a block diagram of a computing system operable to execute location-based services using names and PPOI information in accordance with the disclosed architecture.

FIG. 10 illustrates a schematic block diagram of an exemplary computing environment for location-based services using PPOI information.

### DETAILED DESCRIPTION

The disclosed framework is a location-based service that allows users to denote location information based on a relationship to personal-points-of-interest (PPOI) information. Input can be in the format of text and/or speech, which when processed (e.g., recognized) returns and presents the location information to an application or dialog system. The PPOI information is referenced by a name such as a common name or a nickname, for example. Hence, the user can input a query for the location information in a natural language speech input based on the name. The name is parsed from the query and processed to determine the associated PPOI information, which identifies to location information to be processed.

In the framework, the definition of location is varied by a context manager, based on the granularity required for a particular task. For example, some tasks may require only knowing the user's current city or neighborhood while others require the system to know the user's precise location. The framework engages with the user to obtain the required location information in the most efficient way.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

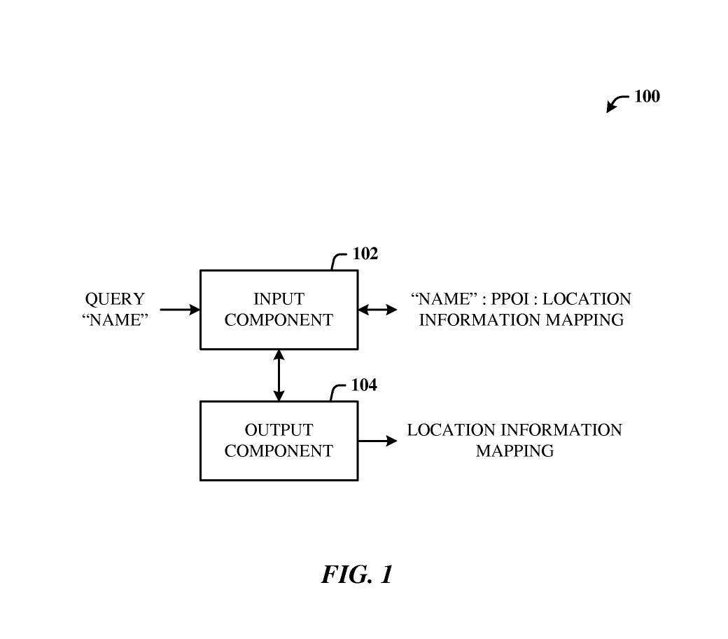

FIG. 1 illustrates a location-based system 100 for providing location information based on PPOI. The system 100 includes an input component 102 for receiving a name associated with PPOI information of a user as part of a query for location-based information. An output component 104 processes the name to retrieve and present the location-based information. This is facilitated by a mapping of the name to the PPOI information and the location information.

The name can be received as a natural language query. The input mechanism by which the query is received can be speech though a voice communications device (e.g., phone) and/or text input that is analyzed to find the name, which can be a common name or a nickname. The common name and nickname are derived from the user as a personal preference for identifying PPOI information and then assigned (or tagged) to the user in a database using an owner identifier.

Following is an exemplary dialog between a user and the disclosed PPOI framework when embodied as a telephone dialog system, where U is the user and S is the system.
S: Welcome. Would you like traffic, gas prices, or weather?
U: I need the closest gas station to my gym.
S: Did you say gym?
U: Yes.
S: The nearest gas station is at the corner of NE 24th Street and 148th Avenue NE.
S: What else can I help you with?
U: How's the traffic between home and work?
S: I'll get the traffic between home and work, right?
U: Yes.
S: The traffic between home and work, via SR-520, is . . . .
S: What else can I help you with?
U: Nothing, thanks.
S: Good bye.

In another example, receiving a natural language input of “Where is the closest gas station to home?” is converted to “Where is the closest gas station to 47.0033 degrees latitude and −122.567 degrees longitude?” This is the process of using the PPOI information for denoting locations in the user input. Then the latitude/longitude coordinates are passed to the application (gas prices/stations) and the application returns “The closest gas station to 47.0033 degrees latitude and −122.567 degrees longitude is at . . . ”, which is converted back to “The closest gas station to home is at . . . ”.

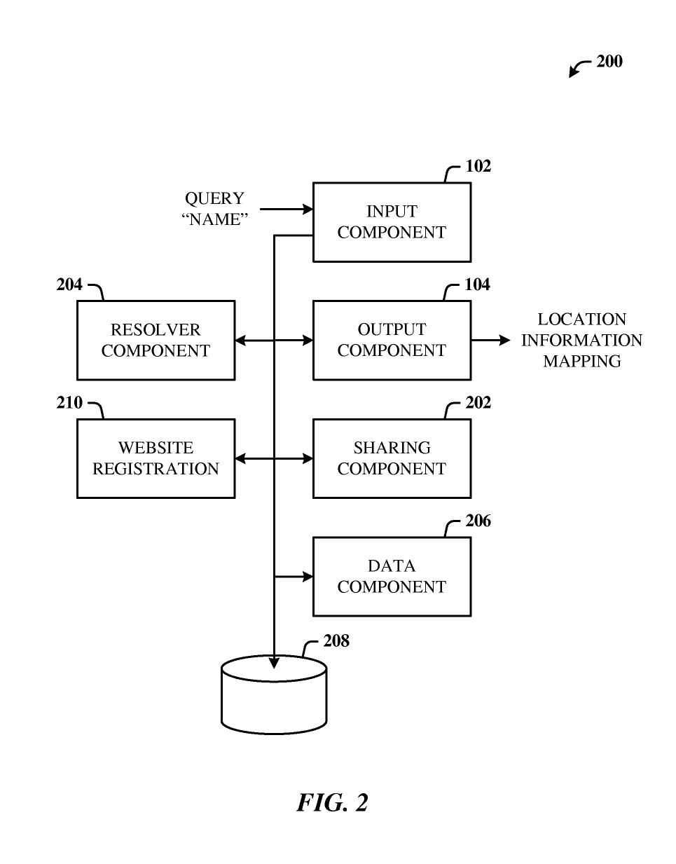

FIG. 2 illustrates an alternative system 200 for acquiring and supporting PPOI information for location-based services. The input component 102 can function to acquire the PPOI information in the format of the common names (e.g., “Pro Sports Club”) and/or nicknames (e.g., “My gym”). Both the common and nicknames are added into the system lexicon and recognition grammars. The PPOI information, common names and/or nicknames can be obtained from other devices or data sources such as a PIM (personal information manager), interactive web services, applications and other sources of personal settings. Each PPOI and name is tagged with the owner (an owner identifier) who defined it.

The PPOI information can be shared as well via a sharing component 202. The common names of PPOI information entered and labeled by a community of users provide a rich set of points-of-interest (POI) information for the benefit of other users as well. In other words, during a creation phase for a name of a PPOI, other names given to the PPOI can be presented for use. If two different PPOIs are given the same common names by two different users, a conflict arises, in which case, the specific name will not be allowed to be used by the rest of users due to the ambiguity in semantics.

When a common name is identified, if there is conflict (e.g., there are several branches of the “Pro Sports Club”) a resolver component 204 is provided to disambiguate the name further, if the user does not own the name or PPOI information. When a nickname is identified (e.g., “My gym”), the nickname is completely dropped if the user does not own the currently associated PPOI. Additionally, the common name can be used for confirmation and reference when delivering the PPOI information.

As a benefit to sharing the PPOI information, the task of entering the PPOI information is facilitated by automatically popping up common names and attributes (e.g., phone numbers, addresses, etc.) that other users have entered for the same nickname. Additionally, only the PPOI information for public POI will be shared (e.g., “My gym”, but not “My home”). Thus, other users will not be privy to the private information of another user.

A data component 206 facilitates the data mining from the accumulation of the PPOI information in a database 208. PPOI information can provide information about the specific user. Accordingly, the PPOI information can be used to harvest the demographic information and personal preferences which are useful to provide targeted services and advertisements (content), for example. Examples of demographic information include gender and marital status (e.g., “My wife's office”, “My daughter's school”), lifestyle and interested activities (e.g., “My gym”, “My art class”), work and home, income level, favorite restaurants and types of restaurants, and ethnicity group (this information can be used to select the acoustic models, to achieve higher accuracy, to provide targeted advertisements, and improve system performance).

The system 200 can also include an optional website registration 210 for users. Users can create an account, provide a phone number, and specify any number of PPOI information. The PPOI information can be specified by a friendly name (e.g., “Jane's school”), an optional formal name (e.g., “Washington Middle School”), and an address. A back-end web service converts this address to a geolocation and this information is stored in the database 208. By default, the user is prompted to register home and work as personal locations which can provide the boundary points for an everyday work profile, for example. Users can then add additional PPOI relative to the work/home PPOI information.

Each time a user changes PPOI information, the database 208 is updated and the recognition grammars are regenerated to reflect the current list of unique PPOI friendly names and formal names. When a user calls the system 200, caller ID is performed, and grammar entries corresponding to the user's PPOI are activated. The caller's phone number and the recognized PPOI information in the input query are then used to retrieve the corresponding location information from the database 208.

The presence of PPOI information also enables the system to assume default behaviors. For example, if a registered user calls the system during common commuting times, the system 200 will automatically fill the semantic slots with the home and work locations of that user and inquire if the user would like the traffic information from home to work (or vice versa).

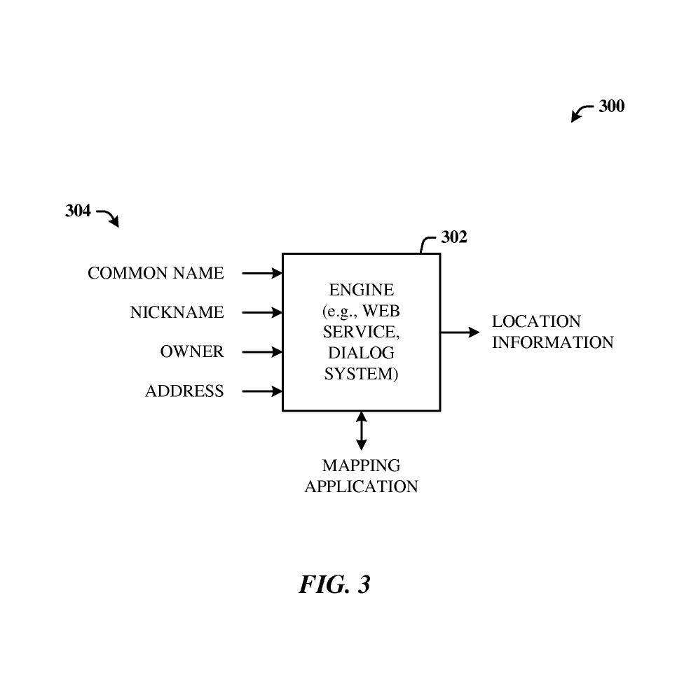

FIG. 3 illustrates the inputs provided and related for location-based services based on PPOI information. Here, an engine 302 (e.g., a web service, voice dialog system) receives input information 304 in the form of a common name, nickname, owner name and/or address from the user during a name creation phase. Once provided, the engine 302 can process some or all of the input information 304 for transmission to a mapping application, which provide geolocation information fir ultimately determining the location information.

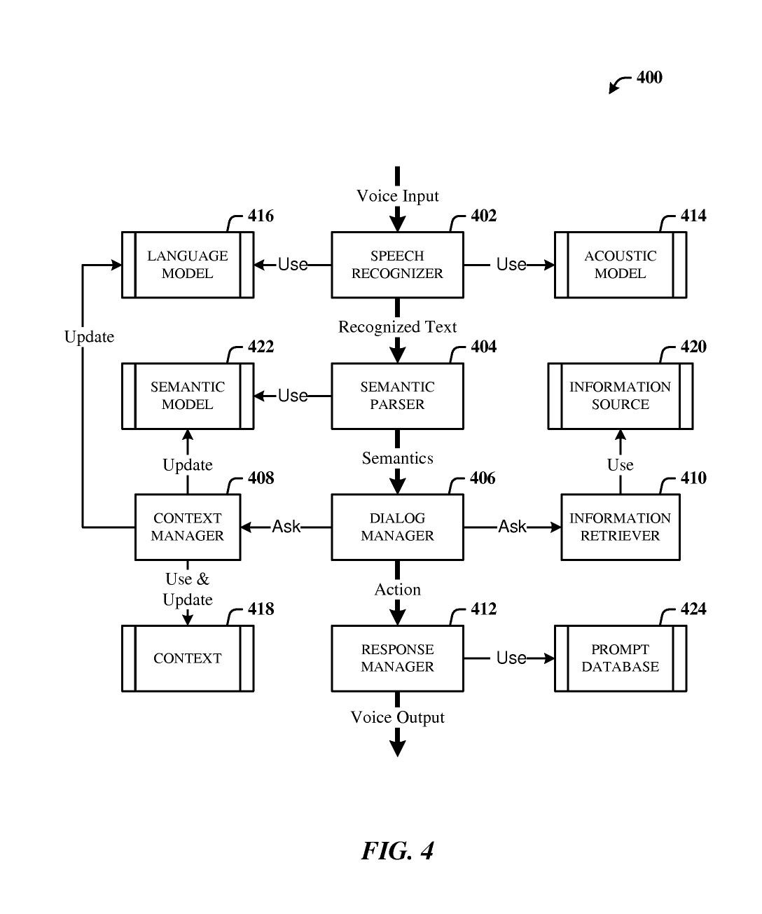

FIG. 4 illustrates an exemplary speech dialog system 400 for obtaining location-based services based on PPOI information. In each instance of receiving voice input of the user, the system 400 processes the input and reacts to the user accordingly. Six functional modules can be involved in this process: a speech recognizer 402, a semantic parser 404, a dialog manager 406, a context manager 408, an information retriever 410, and a response manager 412.

The task of the speech recognizer 402 is to convert the voice input into text, from which semantic information can be extracted and processed. Performance of the speech recognizer 402 directly affects the task completion rate and the user satisfaction. Note that an acoustic model 414 accessed by the speech recognizer 402 is usually independent of the task. However, a language model (LM) 416 (also accessible by the speech recognizer 402) is highly task-dependent and the quality of the LM 416 can determine the recognition accuracy of the speech recognizer 402.

The design of the LM 416 is a balance between the accuracy of the keyword recognition and the flexibility of the speaking style which can be supported. The system 400 utilizes a strategy that trains a statistical LM from the slots (e.g., city name, road name, gas type) and information bearing phrases learned from sample queries (e.g., “ . . . the closest gas station in <City> . . . ”), and augments the LM 416 with a filler word N-gram to model the insignificant words. The filler part of the LM 416 absorbs hesitations, by-talk, and other non-information bearing words unseen in the training sentences. The filler word N-gram can be pruned from a generic dictation LM.

The semantic parser 404 extracts the semantic information from the recognized text output from the speech recognizer 402. Converting information into the associated semantic representation has two benefits. First, a semantic representation is more concise and consistent than the phrases. Using a semantic representation greatly simplifies the subsequent processing in the later stages. Second, a semantic representation is modality independent. By converting information into the same semantic representation, the rest of the system is isolated from different input modalities. New modalities can then be added.

Extracting semantic information, however, is not trivial, especially since the output from the speech recognizer 402 contains errors and users may convey multiple semantics in one utterance. The semantic information extracted includes the task classification, which is a generic call-routing problem, and task-specific semantic slots (e.g., origin city, destination city, time of day for weather forecast, etc.). Slot labeling can be performed using a maximum entropy classifier trained from the same LM training sentences.

The task of the dialog manager 406 is to determine the appropriate actions to take, given the current dialog context and the newly extracted semantic information. Note that both the speech recognizer 402 and the semantic parser 404 are not results certain. Thus, the confidence of the results needs to be taken into consideration when a decision is to be made.

The dialog management is based on a two-level state machine: the turn level and the dialog level. The turn level state machines are configurable and reusable dialog components such as a system-led dialog component and a mixed initiative dialog component. The state machines define the basic behaviors of a turn, for example, what to do when the confidence is low, medium, and high, and what to do when silence or mumble input is detected. The dialog level (inter-turn) state machine defines the flow and strategy of the top level dialog, for example, what to do if the system 400 cannot recognize what the user has said after trying multiple times (e.g., twice).

The top level state machine is designed to support both free-form mixed initiative and strict system-led dialog. If the system 400 cannot decipher some of the semantic slots in free-form utterances of the user, the system 400 falls back to the system-led dialog and guides the user step-by-step to achieve the user's goal. The user can also yield to the system-led dialog from the very beginning. The dialog manager 406 obtains context information 418 from the context manager 408 and the information requested by the user from an information source 420 through the information retriever 410. The information and prompts are delivered to the user through the response manager 412.

The context manager 408 provides access to the context information 418. The contexts can include the user information (e.g., user registered places, user name, and past requests), the dialog history, and the semantic information confirmed so far. By maintaining current and accurate context information, the context manager 408 can resolve semantic conflicts and make the system 400 synchronous to the user's perceived state. The context manager 408 updates the LM 416 and a semantic model 422 based on the context. By choosing the context-dependent LM 416 and the semantic model 422, the system 400 reduces the perplexity and achieves higher recognition accuracy and lower number of turns.

The information retriever 410 provides an interface between the dialog manager 406 and the backend information sources 420. The information can be from at least three major sources: a relatively stable geographical database (which contains information such as cities, streets, intersections, and points of interest); the rapidly changing real-time information such as gas prices, traffic conditions, and weather conditions; and the user's registered information such as telephone numbers and PPOI.

The response manager 412 presents information to the user or prompts the user for additional information using a prompt database 424. In support of a voice presentation modality, a task of the response manager 412 is to utilize the prompt database 424, synthesize the audio output, and present the audio to the user. The system 400 can employ several strategies to decide the optimum manner in which to output speech information to the user.

The dialog system 400 for location-based services is designed to reliably understand the locations spoken by the user. However, the notion of location and the granularity of location can vary significantly based on the task. For example, for traffic or weather applications, a broad definition of location, such as neighborhood, city, or zip code, can be adequate, (e.g., “How's the traffic between Seattle and Bellevue?”). However, for other tasks such as finding the nearest gas station, or route planning, the user conveys a precise location to the system 400. Moreover, distinctions are made between personal locations that can vary based on the user (e.g., home and work) and geographic entities that have standard names and meanings.

In order to perform recognition of locations, a geographic database is crawled and the relevant information (e.g., the entity name, entity type and geolocation (latitude/longitude) or bounding box) is stored in a relational database. The database structure enables the hierarchical categorization of locations in a given state: a state contains cities, cities contain neighborhoods and points of interest, etc. All of these entities are valid locations in the application and are thus added to the recognition grammar.

When the user makes a query, the semantic parser 404 processes the recognized text and isolates locations in the spoken utterance. These locations are then passed to a database of the backend information source 420 to find the location data for that entity. The database is searched from most specific location (e.g., PPOI) to the most general (e.g., city or zip code) in order to determine the user's intended location.

In some cases, the task itself dictates the scope of the location grammar. For example, in one implementation, traffic information is only available on major highways, and not local roads. Because the traffic information for local roads is not provided, a traffic query does not require the same precision in origin and destination as a task such as route planning. As a result, the task can be simplified allowing users to make traffic queries only on the roads themselves (“How's the traffic on 1-5 north?”), or between cities, neighborhoods, or personal points of interest (“How's the traffic between Bellevue and Seattle?”). This enables the dialog to be much more concise (e.g., the user does not have to convey two exact addresses) and because the grammar is more constrained, the accuracy is higher.

In an alternative embodiment, traffic information for local roads is made available. This information can be obtained from third-party data sources (e.g., websites) where the granularity is to the street level or even lower.

There are cases where the user's query can lead to ambiguities. For example, suppose the user asks for the traffic between two cities, and there are two common routes between the origin and destination. The system 400 will choose the most common route, and attempt to resolve the ambiguity by informing the user of the route it has chosen, as represented in the following dialog:
U: How's the traffic between Bellevue and Seattle?
S: The traffic between Bellevue and Seattle, via I-90 is light, with an average speed of . . . .

In this case, the system 400 (denoted S:) informed the user (denoted U:) that traffic information provided was for the route taking Interstate 90. The user, who presumably knows both routes, can then query for the other route, by asking, “How about via 520?” The context manager 408 maintains the origin and destination cities from the previous query and adds Highway 520 as a road to be included in the route between Bellevue and Seattle. A routing engine (not shown) will then determine the route between the two cities that takes Highway 520, and then the corresponding traffic information can be retrieved and delivered to the user.

There are many instances where the user needs to convey an exact location to the system 400, and not simply a city or neighborhood region, for example, if the user needs to find the closest gas station, or would like directions between two places. One way to convey an exact location is using an address. However, users often do not know a valid address for the current location, especially while they are driving. Even if an address were known, recognition errors make the use of addresses inefficient in conveying location.

To employ and reliably recognize intersections, an information retrieval approach is utilized. The information source 420 is a database of streets and intersections in a particular city. The intersections are treated as documents in a database, and phonetic-level features are derived from the word stings comprising these “documents”. When the user utters an intersection, the recognized text is parsed into two street names and the phonetic level features are extracted each street name. Intersection classification is then performed using a vector space model with term frequency/inverse document frequency (TF-IDF) features. This approach allows the system 400 to reliably recognize intersections in the presence of recognition errors and incomplete street names.

The ability for the user to understand and remember the locations spoken by the system 400 is as important as the system's ability to understand the locations input by the user. Conveying locations to users in spoken dialog systems is problematic for several reasons. First, depending on the quality of the TTS voice, understanding a spoken location can be quite difficult, even in optimal conditions. In a vehicle, the environmental noise can make intelligibility even harder. The situation is exacerbated by the high cognitive load required by driving, so the user cannot fully focus on the system's output speech. In addition, because the user's hands and eyes are typically busy, the user cannot write down the location as the system speaks it, and therefore must try to remember the location as closely as possible.

To enable users to more easily understand locations, spoken by the system, the system output is modeled on the manner in which humans convey locations to each other. For example, a user calling a business to ask its location will often be told by the clerk, “We're on the corner of 40th and 148th,” rather than “We're located at 14803 40th Street.” Similarly, humans will often use land-marks, such as “We're on Main Street near the Shell Station” or “We're on the corner of Fifth and Mercer, near the Space Needle”.

To create the capability in the system 400, a geographic database is crawled that contains all streets and intersections and associated latitude/longitude coordinates in a particular city. In addition, a database of points of interest (POI) and labeled with geographic coordinates can also be crawled. The POI include a variety of entities, such as schools, libraries, parks, and government buildings. The information about streets, intersections and POI are stored in a database.

Using this information, locations to be conveyed to users such as the location of a gas stations, can be processed as follows. The address of the entity is converted to geographic coordinates. Using the coordinates, the intersections database is queried to find all intersections within 0.05 miles (approximately half a block). If multiple intersections are returned, the intersections are ranked according to an intersection importance metric, defined as the sum of the total number of other intersections of which each constituent street in the given intersection is a member. The top ranked intersection is selected. Following the intersection search, the POI database is queried to identify any POI within 0.1 miles (one block) from the entity of interest.

After this process, each location returned to the user is represented by its original address, as well as the nearest intersection and/or landmark, if either was found. For those locations that do have a nearby intersection and landmark, the location can be defined by address only, address and POI, intersection only, and intersection and POI. When using PPOI, it was determined that PPOI enables users to obtain information efficiently with fewer dialog turns. The use of PPOI results in fewer turns in the dialog and leads to significantly higher task completion rate for registered users.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

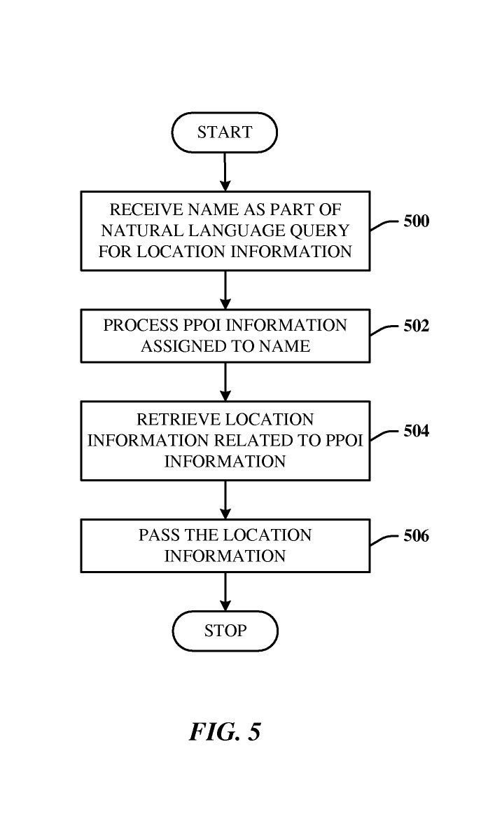

FIG. 5 illustrates a method of providing location-based services. At 500, a name is received as part of a natural language query for location information. At 502, PPOI information assigned to the name is processed. At 504, location information related to the PPOI information is retrieved. At 506, the location information is then passed.

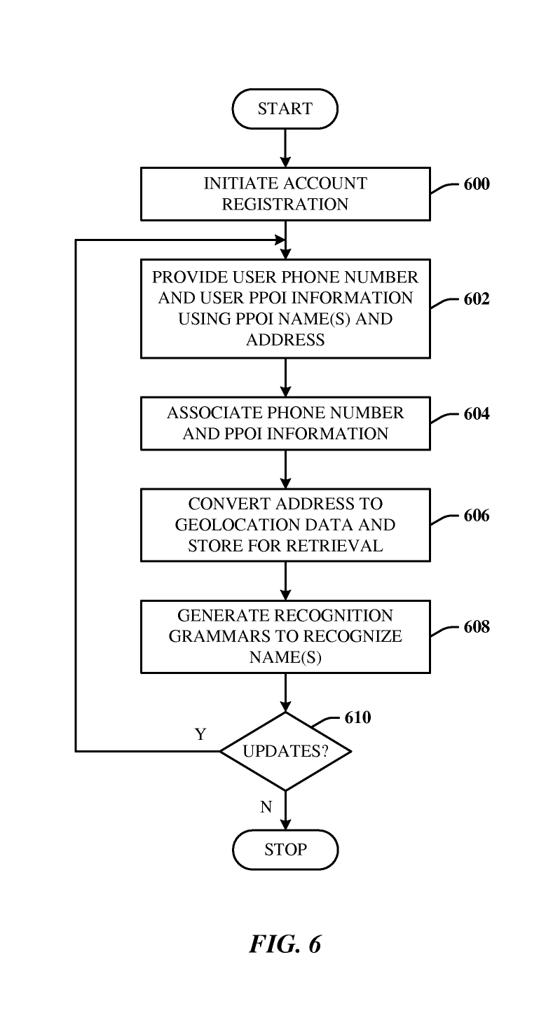

FIG. 6 illustrates a method of registering for location-based services using PPOI information. At 600, account registration is initiated. This can be via a web-based service. At 602, the user provides a user phone number (as the User ID) and user PPOI information using PPOI name(s) and address. At 604, the phone number is associated with the PPOI information. At 606, the address is converted to geolocation data and stored for retrieval. At 608, recognition grammars are generated based on the provided name(s). At 610, a check is made to determine is PPOI updates are provided. If so, flow is from 610 to 602 to repeat the process. If not, flow is from 610 to 612 to end the process.

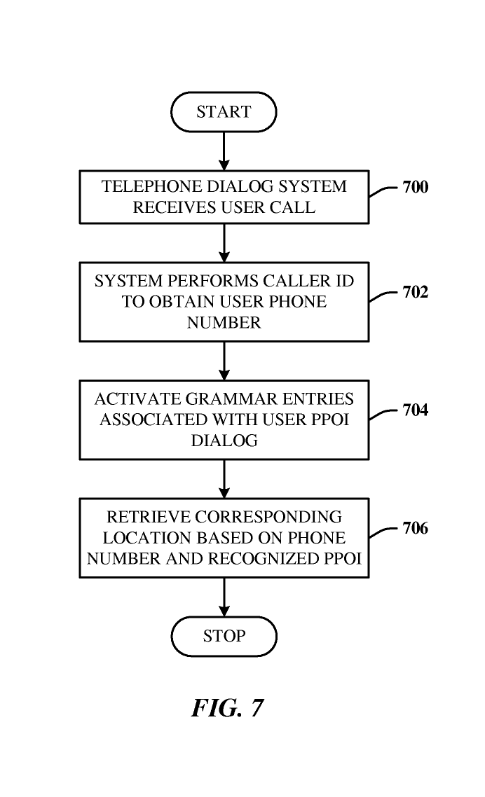

FIG. 7 illustrates a method of retrieving location-based information based on a phone call. At 700, a telephone dialog system receives a user call. At 702, the system performs caller ID (caller identification) processing to obtain the user phone number. At 704, the system activates grammar entries associated with the user PPOI dialog. At 706, the corresponding location is retrieved based on the phone number and recognized PPOI information in the call dialog.

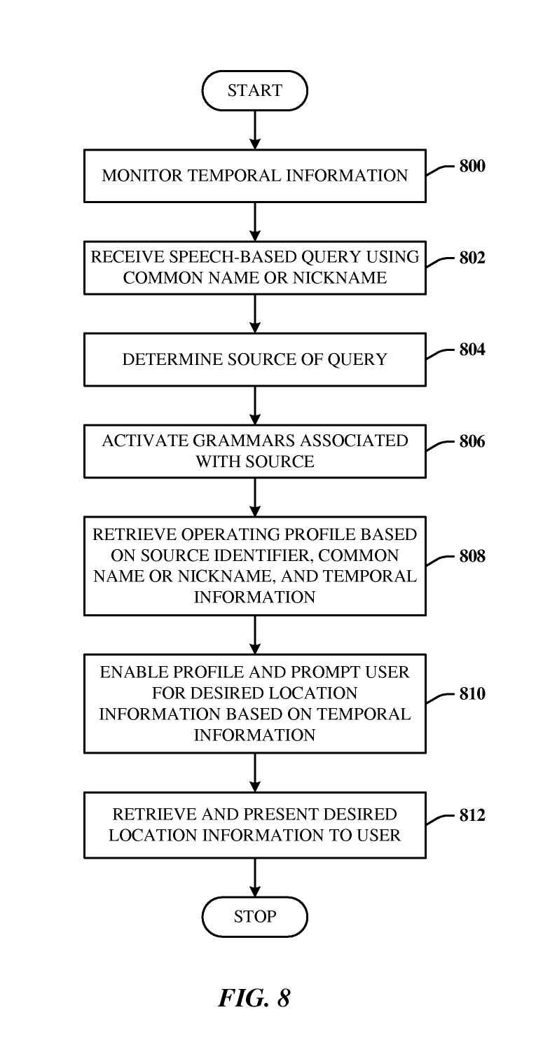

FIG. 8 illustrates a method of automatically enabling a default operating profile based on temporal information. At 800, temporal information (e.g., time, date, day, week, etc.) is monitored. At 802, a speech-based query is received using a common name and/or nickname. At 804, the source (e.g., identified by a specific phone number, or computer IP address) of the query is determined. At 806, grammars associated with the source are activated. At 808, an operating profile is retrieved based on the common name or nickname, and temporal information. For example, if the time is associated with rush hour, the operating profile can include names of PPOI between home and work for obtaining traffic conditions. If the time is associated with after-work dining, a profile associated names of PPOI between home and a favorite restaurant can be activated for obtaining with traffic conditions, weather, and so on. At 810, the profile is enabled and the user prompted for the desired location information based on the temporal information. At 812, the location information is retrieved and presented to the user.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

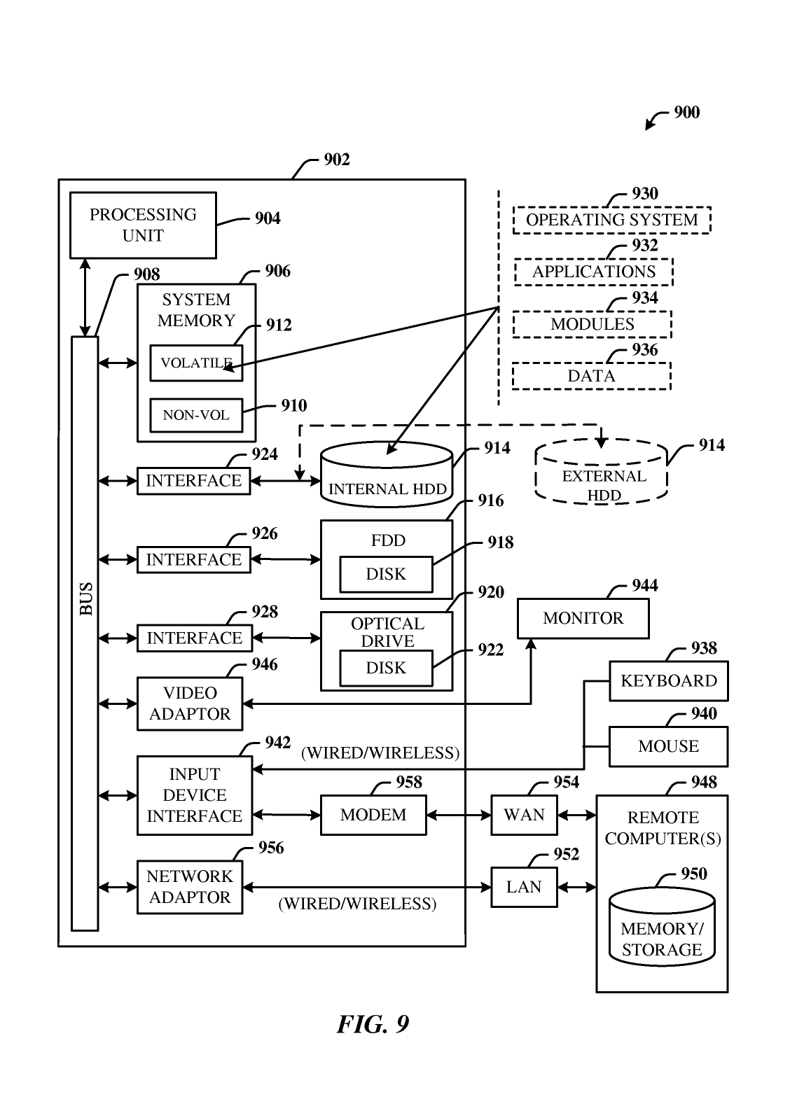

Referring now to FIG. 9, there is illustrated a block diagram of a computing system 900 operable to execute location-based services using names and PPOI information in accordance with the disclosed architecture. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS contains the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. The operating system 930, one or more application programs 932, other program modules 934, and program data 936 can include the input component 102, output component 104, sharing component 202, resolver component 204, data component 206, database 208, website registration 210, engine 302, and entities of system 400, for example.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

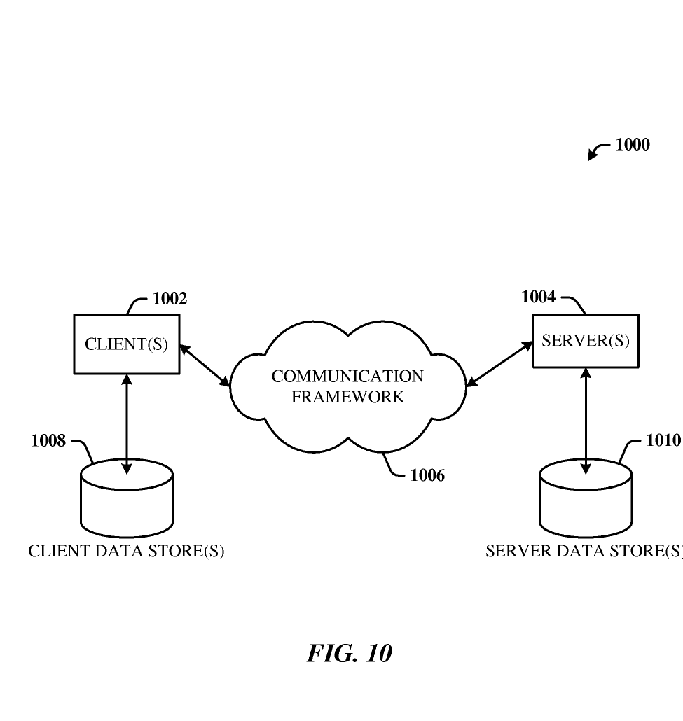

Referring now to FIG. 10, there is illustrated a schematic block diagram of an exemplary computing environment 1000 for location-based services using PPOI information. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

The systems 100, 200 and 400 can be implemented as a client/server computing environment. For example, the clients 1002 can be part of phones for recognizing speech input, parsing common names or nicknames and interacting with services for caller ID, PPOI information and location information. The database can be network-based or client-based.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A location-based system, comprising:
an input component for receiving a name associated with personal points-of-interest (PPOI) information of a user as part of a query for location-based information; and
an output component for processing the name to retrieve and present the location-based information.

2. The system of claim 1, wherein the name of the PPOI information is received in a natural language query.

3. The system of claim 1, wherein the name is a common name or a nickname.

4. The system of claim 1, wherein the PPOI information is assigned to the user that defined the name.

5. The system of claim 1, further comprising a sharing component for sharing the name of the PPOI information with other users.

6. The system of claim 1, wherein the query is received as a voice input.

7. The system of claim 1, further comprising a resolver component for resolving a conflict of the name with another name for the PPOI information.

8. The system of claim 1, further comprising a data component for harvesting demographic and personal preferences data from PPOI information of the user to provide targeted advertising and services.

9. A computer-implemented method of providing location-based services, comprising:
receiving a name as part of a natural language query for location information;
processing the PPOI information assigned to the name;
retrieving the location information related to the PPOI information; and
passing the location information.

10. The method of claim 9, wherein the natural language query is received via a voice communications device from which caller identification is obtained and grammar entries in a dialog system are activated.

11. The method of claim 9, further comprising receiving the name from settings stored in a device.

12. The method of claim 9, further comprising tagging the PPOI information with an owner identifier that identifies a user that defined the created the PPOI information.

13. The method of claim 9, further comprising sharing the PPOI information with one or more other users.

14. The method of claim 9, further comprising disambiguating the name during a creation process.

15. The method of claim 9, further comprising employing the name for confirmation and reference when delivering the PPOI information.

16. The method of claim 9, further comprising automatically presenting names and attributes of PPOI information generated by other users when creating the name.

17. The method of claim 9, further comprising restricting presentation of other user PPOI information to public PPOI information during creation of the name.

18. The method of claim 9, further comprising targeting a user with services and content based on PPOI information associated with the user.

19. The method of claim 9, further comprising automatically defaulting to an operating profile based on at least one of temporal or spatial information, and prompting a user for a type of the location information based on the temporal or spatial information.

20. A computer-implemented system, comprising:
computer-implemented means for receiving a name as part of a natural language query for location information;
computer-implemented means for processing the PPOI information assigned to the name;
computer-implemented means for retrieving the location information related to the PPOI information; and
computer-implemented means for presenting the location information.
